(19) United States
(12) Patent Application Publication
(10) Pub. No.: US 2024/0112398 A1
(43) Pub. Date: Apr. 4, 2024

(54) PLANT MODEL GENERATION METHOD AND APPARATUS, COMPUTER DEVICE AND STORAGE MEDIUM

(71) Applicant: SHENZHEN UNIVERSITY, Shenzhen, Guangdong (CN)

(72) Inventors: Qian ZHENG, Shenzhen (CN); Hui HUANG, Shenzhen (CN)

(21) Appl. No.: 17/769,146

(22) PCT Filed: Oct. 26, 2020
(86) PCT No.: PCT/CN2020/123549

§ 371 Date: Apr. 14, 2022

(30) Foreign Application Priority Data
Aug. 31, 2020 (CN) 202010897588.0

(51) Int. Cl. G06T 17/00; G06T 7/11; G06T 7/73; G06T 15/20

(52) U.S. Cl. CPC G06T 17/00; G06T 7/11; G06T 7/75; G06T 15/20; G06T 2207/10028; G06T 2207/20081; G06T 2207/30188

(57) ABSTRACT

The present disclosure relates to a plant model generation method and apparatus, a computer device and a storage medium. The method includes: acquiring a plant image and first point cloud data that correspond to a target plant; segmenting the plant image through a leaf segmentation model to obtain a leaf segmentation result, and determining a to-be-sheared target leaf according to the leaf segmentation result; shearing the target leaf of the target plant to acquire second point cloud data corresponding to the target plant after shearing; and determining a leaf model corresponding to the target leaf according to the first point cloud data and the second point cloud data, and generating a target plant model corresponding to the target plant according to the leaf model.

### CROSS-REFERENCE TO RELATED APPLICATIONS

This application claims priority to Chinese Patent Application No. 202010897588.0, filed with the Chinese Patent Office on Aug. 31, 2020 and entitled “PLANT MODEL GENERATION METHOD AND APPARATUS, COMPUTER DEVICE AND STORAGE MEDIUM”, the entire contents of which are incorporated herein by reference.

### TECHNICAL FIELD

The present disclosure relates to a plant model generation method and apparatus, a computer device and a storage medium.

### BACKGROUND

Three-dimensional plant modeling is an important and widely used research topic in computer graphics. For example, in game development, the quality of a plant model in a game scenario may affect how realistic a game is. In the field of botany, plant models may be configured to study growth of plants and their behaviors in different environments, which facilitates research such as pest control and crop fertilization.

Conventionally, depth information of a plant is scanned by a scanning device, and a plant model is reconstructed directly according to the depth information.

### SUMMARY

The present disclosure provides a plant model generation method, including: acquiring a plant image and first point cloud data that correspond to a target plant; segmenting the plant image through a leaf segmentation model to obtain a leaf segmentation result, and determining a to-be-sheared target leaf according to the leaf segmentation result; shearing the target leaf of the target plant to acquire second point cloud data corresponding to the target plant after shearing; and determining a leaf model corresponding to the target leaf according to the first point cloud data and the second point cloud data, and generating a target plant model corresponding to the target plant according to the leaf model.

The present disclosure further provides a plant model generation method, including: collecting a plant image and first point cloud data that correspond to a target plant, and determining whether a target leaf is detected through the plant image; adjusting an observation perspective corresponding to the target plant and re-acquiring the plant image and the first point cloud data if no; shearing the target leaf to acquire second point cloud data corresponding to the target plant after shearing if yes; determining a leaf position and a leaf model that correspond to the target leaf according to the first point cloud data and the second point cloud data; and determining whether the leaf of the target plant has been sheared; re-acquiring the plant image and the first point cloud data that corresponding to the target plant after shearing if no; and combining the leaf models corresponding to a plurality of leaves respectively according to the leaf position to obtain a target plant model corresponding to the target plant.

The present disclosure further provides a plant model generation apparatus, including: an image acquisition module configured to acquire a plant image and first point cloud data that correspond to a target plant; a leaf segmentation module configured to segment the plant image through a leaf segmentation model to obtain a leaf segmentation result, and determine a to-be-sheared target leaf according to the leaf segmentation result; and shear the target leaf of the target plant to acquire second point cloud data corresponding to the target plant after shearing; and a model generation module configured to determine a leaf model corresponding to the target leaf according to the first point cloud data and the second point cloud data, and generate a target plant model corresponding to the target plant according to the leaf model.

The present disclosure further provides a computer device, including a memory and a processor, the memory storing a computer program, and the computer program, when executed by the processor, implementing steps of the plant model generation method described above.

The present disclosure further provides a computer-readable storage medium, having a computer program stored thereon, the computer program, when executed by a processor, implementing steps of the plant model generation method described above.

Details effectively improving one or more embodiments of the present disclosure are set forth in the following accompanying drawings and descriptions. Other features, objectives, and advantages of the present disclosure become obvious with reference to the specification, the accompanying drawings, and the claims.

### BRIEF DESCRIPTION OF THE DRAWINGS

In order to more clearly illustrate the technical solutions in embodiments of the present disclosure, the accompanying drawings used in the description of the embodiments will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a diagram of an application environment of a plant model generation method according to an embodiment;

FIG. 2 is a schematic flowchart of a plant model generation method according to an embodiment;

FIG. 3(a) is a schematic diagram of first point cloud data according to an embodiment;

FIG. 3(b) is a schematic diagram of second point cloud data according to an embodiment;

FIG. 3(c) is a schematic diagram of difference point cloud data according to an embodiment;

FIG. 4 is a schematic flowchart of plant model generation according to an embodiment;

FIG. 5 is a schematic flowchart of a step of generating training data according to an embodiment;

FIG. 6(a) is a schematic diagram of simulation corresponding to Scindapsus aureus according to an embodiment;

FIG. 6(b) is a schematic diagram of simulation corresponding to Schefflera octophylla according to an embodiment;

FIG. 6(c) is a schematic diagram of simulation of Anthurium andraeanum according to an embodiment;

FIG. 7 is a structural block diagram of a plant model generation apparatus according to an embodiment; and

FIG. 8 is a diagram of an internal structure of a computer device according to an embodiment.

### DETAILED DESCRIPTION OF THE EMBODIMENTS

Due to occlusion between leaves, shapes or distribution information of plant leaves cannot be accurately obtained, which leads to low accuracy and completeness of a generated plant model.

In order to make the objectives, technical solutions and advantages of the present disclosure clearer, the present disclosure is described in further detail below with reference to the accompanying drawings and embodiments. It should be understood that specific embodiments described herein are intended only to interpret the present disclosure and not intended to limit the present disclosure.

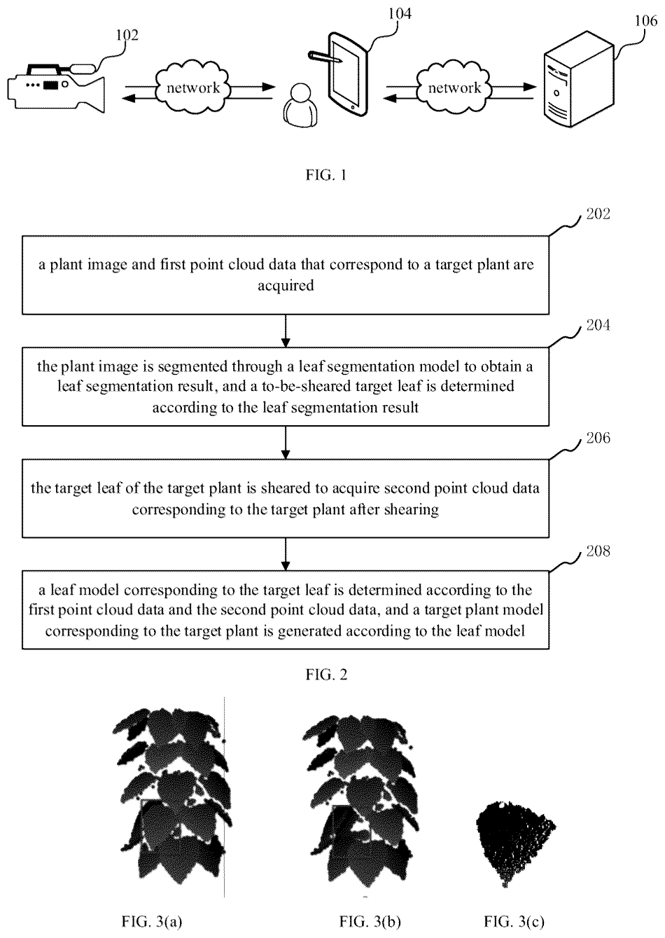

A plant model generation method according to the present disclosure can be applied to the application environment shown in FIG. 1. A terminal 104 may communicate with a data collection device 102 and a server 106 through a network. The terminal 104 acquires a plant image and first point cloud data that correspond to a target plant collected by the data collection device 102. The terminal 104 sends a leaf segmentation request to the server 106, the leaf segmentation request carrying the plant image, so that the server 106 segments the plant image through a leaf segmentation model to obtain a leaf segmentation result, and sends the leaf segmentation result to the terminal 104. The terminal 104 receives the leaf segmentation result sent by the server 106, determines a to-be-sheared target leaf according to the leaf segmentation result, cuts the target leaf of the target plant, and acquires second point cloud data corresponding to the target plant after shearing collected by the data collection device 102. The terminal 104 determines a leaf model corresponding to the target leaf according to the first point cloud data and the second point cloud data, and generates a target plant model corresponding to the target plant according to the leaf model. The data collection device 102 may include, but is not limited to, an image collection device and a point cloud data collection device. The terminal 104 may include, but is not limited to, a variety of personal computers, laptops, smartphones, tablets and portable wearable devices. The server 106 may be implemented using a separate server or a server cluster composed of a plurality of servers.

In one embodiment, as shown in FIG. 2, a plant model generation method is provided. In an example where the method is applied to the terminal 104 in FIG. 1, the method includes the following steps.

In step 202, a plant image and first point cloud data that correspond to a target plant are acquired.

The target plant is a plant object used as a standard for plant model generation, so as to generate a more accurate and complete plant model corresponding to the target plant. The target plant may include, but is not limited to, at least one of various types of indoor plants. The indoor plants are compared to outdoor plants. The outdoor plants generally include trees, etc., and plant models thereof focus on trunks, branches and other structures of the trees. Plant models corresponding to the indoor plants mainly focus on shapes of plant leaves, a position relationship between the leaves, and the like. For example, the target plant may include, but is not limited to, at least one of Scindapsus aureus, Schefflera octophylla and Anthurium andraeanum.

The terminal may acquire a plant image and first point cloud data that correspond to a target plant. Specifically, the terminal may communicate with a data collection device based on a pre-established connection and acquire a plant image and first point cloud data that correspond to the target plant collected by the data collection device in real time. The terminal and the data collection device may be connected in a wired or wireless manner. The terminal may also acquire pre-collected plant images or first point cloud data locally or from a server.

The plant image may specifically be an RGB image corresponding to the target plant. The first point cloud data refers to point cloud data corresponding to the target plant prior to shearing. Understandably, “first”, “second” and the like are intended to distinguish different point cloud data and are not intended to limit a sequence between the point cloud data. The point cloud data is a set of point data corresponding to a plurality of points on a surface of a plant recorded in a form of points by scanning the plant. The point data may specifically include at least one of three-dimensional coordinates, laser reflection intensity and color information corresponding to the points. The three-dimensional coordinates may be coordinates of the points in a Cartesian coordinate system, specifically including horizontal-axis coordinates (x axis), longitudinal-axis coordinates (y axis), and vertical-axis coordinates (z axis) of the points in the Cartesian coordinate system.

In step 204, the plant image is segmented through a leaf segmentation model to obtain a leaf segmentation result, and a to-be-sheared target leaf is determined according to the leaf segmentation result.

The leaf segmentation model is an instance segmentation model established based on an instance segmentation network and obtained by pre-training. The leaf segmentation model is one of a plurality of convolutional neural network models. For example, the leaf segmentation model may specifically be a neural network model established based on one of a CNN (Convolutional Neural Networks), an R-CNN (Region-CNN), an LeNet, a Fast R-CNN and a Mask R-CNN. The leaf segmentation model obtained by training may be pre-configured in the terminal, so that the terminal calls the leaf segmentation model for segmentation.

The terminal, after acquiring the plant image corresponding to the target plant, can call the pre-configured leaf segmentation model, input the plant image into the leaf segmentation model, and segment the plant image through the leaf segmentation model, to obtain a leaf segmentation result outputted by the leaf segmentation model. Specifically, the leaf segmentation model may specifically be a convolutional neural network model. The leaf segmentation model may include, but is not limited to, an input layer, a convolution layer, a pooling layer, a fully connected layer and an output layer. Convolution, pooling and other processing are performed on the plant image through the leaf segmentation model, so as to semantically segment the plant image corresponding to the target plant to obtain a leaf segmentation result corresponding to the image. The leaf segmentation result includes a semantic result corresponding to each pixel in the plant image and confidence degrees corresponding to a plurality of leaves obtained after segmentation respectively. The semantic result may indicate whether the pixel belongs to a leaf and whether different pixels belonging to leaves belong to a same leaf.

The terminal may determine the to-be-sheared target leaf according to the leaf segmentation result outputted by the leaf segmentation model. The target leaf refers to an external leaf of the target plant required to be sheared. Since a plurality of leaves of the target plant have a mutual occlusion relationship, the occlusion of external leaves may easily lead to inaccurate data collection of internal leaves. Therefore, the target leaf is sheared by determining a to-be-sheared target external leaf of the target plant, the point cloud data corresponding to the target leaf can be acquired more accurately and plant internal data of an occluded part of the target leaf can be obtained more accurately.

In step 206, the target leaf of the target plant is sheared to acquire second point cloud data corresponding to the target plant after shearing.

After the to-be-sheared target leaf is determined according to the leaf segmentation result, the target leaf of the target plant can be sheared to obtain the target plant after shearing of the target leaf. The terminal may display the to-be-sheared target leaf through a display interface, and a user manually shear the target leaf of the target plant, or the terminal controls a shearing device such as a mechanical arm to automatically shear the target leaf of the target plant, to obtain the target plant after shearing. The determined target leaf is sheared, which may damage the target plant during a practical application, but an internal leaf structure of the target plant occluded by the target leaf can be observed and acquired more clearly and accurately, thereby being conducive to generating the target plant model corresponding to the target plant more accurately and completely.

After the target plant after shearing is obtained, the terminal may establish a connection with the data collection device to instruct the data collection device to collect second point cloud data corresponding to the target plant after shearing, so as to acquire the second point cloud data corresponding to the target plant after shearing. The data collection device may specifically be a laser sensor or the like, which scans the target plant after the target leaf is sheared and receives a laser signal reflected back from the target plant after shearing, to obtain the second point cloud data corresponding to the target plant after shearing.

In step 208, a leaf model corresponding to the target leaf is determined according to the first point cloud data and the second point cloud data, and a target plant model corresponding to the target plant is generated according to the leaf model.

The terminal may determine the leaf model corresponding to the target leaf according to the first point cloud data and the second point cloud data, and generate the target plant model corresponding to the target plant according to the leaf model. The target plant model is a polygonal representation of the target plant including a mesh or texture. Specifically, since the first point cloud data is point cloud data collected for the target plant prior to shearing of the target leaf and the second point cloud data is point cloud data collected for the target plant after shearing of the target leaf, a difference between the second point cloud data and the first point cloud data is the absence of the target leaf. Therefore, the terminal can compare the first point cloud data with the second point cloud data to obtain difference point cloud data between the first point cloud data and the second point cloud data. Understandably, the difference point cloud data is point cloud data corresponding to the target leaf. The terminal may determine a leaf model corresponding to the target leaf according to the difference point cloud data, and generate the target plant model corresponding to the target plant according to the leaf model corresponding to the target leaf. The difference point cloud data is three-dimensional point cloud data. A three-dimensional leaf model can be determined according to the difference point cloud data, so as to realize three-dimensional modeling of the target plant.

In this embodiment, a plant image and first point cloud data that correspond to a target plant are acquired; the plant image is segmented through a leaf segmentation model to obtain a leaf segmentation result, and a to-be-sheared target leaf is determined according to the leaf segmentation result; the target leaf of the target plant is sheared to acquire second point cloud data corresponding to the target plant after shearing; and a leaf model corresponding to the target leaf is determined according to the first point cloud data and the second point cloud data, and a target plant model is generated corresponding to the target plant according to the leaf model. The to-be-sheared target leaf is determined, and the target leaf is sheared, so that more accurate and complete second point cloud data of the target plant can be acquired. The target plant model is generated according to the leaf model determined according to the first point cloud data and the second point cloud data, which effectively improve the accuracy and completeness of the generated plant model.

In one embodiment, the step of determining a to-be-sheared target leaf according to the leaf segmentation result includes: determining confidence degrees corresponding to a plurality of leaves of the target plant respectively according to the leaf segmentation result; screening out candidate leaves from the plurality of leaves of the target plant according to the confidence degrees; and selecting, from the candidate leaves, the candidate leave satisfying a selection condition as the target leaf, wherein the selection condition includes the confidence degree being greater than a confidence degree threshold or the confidence degree being sorted prior to at least one of those pre-sorted.

The terminal may determine the to-be-sheared target leaf according to the leaf segmentation result outputted by the leaf segmentation model. Specifically, the terminal, after acquiring the leaf segmentation result outputted by the leaf segmentation model, may determine confidence degrees corresponding to a plurality of leaves of the target plant respectively according to the leaf segmentation result. The leaf segmentation result may include a semantic segmentation result of each pixel corresponding to the plant image and respective confidence degrees. The confidence degree may be configured to indicate the likelihood that the corresponding pixel belongs to an external leaf required to be sheared. The confidence degree may be expressed in a form of a percentage, a fraction, a decimal or the like.

The terminal may screen out candidate leaves from the plurality of leaves of the target plant according to the confidence degrees corresponding to the plurality of leaves respectively. The candidate leaves refer to at least one leaf that can be selected as the target leaf from the plurality of leaves of the target plant. The leaf model corresponding to the target leaf can be determined more accurately when the to-be-sheared target leaf is an external leaf of the target plant and faces the data collection device. Therefore, the terminal can perform coarse screening, according to a preset threshold and confidence degree, on the plurality of leaves obtained after segmentation to select the candidate blades from the plurality of leaves, so as to improve the accuracy of the determined target leaf.

The terminal may select, from the screened-out candidate leaves, the candidate leave satisfying a selection condition as the target leaf. The selection condition may be preset according to a practical application requirement. The selection condition includes, but is not limited to, the confidence degree being greater than a confidence degree threshold or the confidence degree being sorted prior to at least one of those pre-sorted. The confidence degree threshold is greater than or equal to a preset threshold for screening candidate leaves. The confidence degree threshold may be a fixed threshold preset according to a practical application requirement or a threshold determined according to a confidence degree corresponding to the candidate leaf. The terminal may select, from the candidate leaves according to the selection condition, the candidate leave satisfying the selection condition, and determine the selected candidate leaf as the to-be-sheared target leaf.

For example, the selection condition may be determined as selecting, from the candidate leaves, the candidate leaf with a maximum confidence degree. The terminal may select, from the candidate leaves, the candidate leaf with the maximum confidence degree as the target leaf through the confidence degree threshold. The terminal may also perform sorting according to the confidence degrees corresponding to the candidate leaves and select the candidate leaf corresponding to the first confidence degree in order of the confidence degrees from large to small as the target leaf.

In this embodiment, confidence degrees corresponding to a plurality of leaves respectively are determined, candidate leaves are screened out from the plurality of leaves of the target plant, and the candidate leave satisfying a selection condition is selected from the candidate leaves screened out as the target leaf, which effectively improve the accuracy of the determined target leaf and helps improve the accuracy of leaf model and target plant model generation.

In one embodiment, the plant image and the first point cloud data are acquired with a first angle as an observation perspective, and the method further includes: adjusting the observation perspective corresponding to the target plant to obtain a second angle when no candidate leaf is screened out from the plurality of leaves of the target plant; and re-acquiring the plant image and the first point cloud data of the target plant at the second angle.

The observation perspective refers to an angle at which the plant image and the first point cloud data of the target plant are collected. Plant images and first point cloud data at different angles that correspond to the target plant may be collected according to different observation perspectives. The terminal may acquire the plant image and the first point cloud data of the target plant collected with the first angle as the observation perspective, segment the plant image through the leaf segmentation model to obtain a leaf segmentation result, determine confidence degrees corresponding to a plurality of leaves in the plant image respectively according to the leaf segmentation result, and screen out candidate leaves from the plurality of leaves according to the confidence degrees. For example, the corresponding leafs with confidence degrees greater than or equal to the preset threshold are screened out from the plurality of leaves as candidate leaves.

When no candidate leaf is screened out from the plurality of leaves of the target plant, for example, when the confidence degrees corresponding to the plurality of leaves are all less than the preset threshold, the observation perspective corresponding to the target plant can be adjusted to obtain a second angle. The observation angle may be automatically adjusted according to a preset adjustment strategy, for example, adjusted 10 degrees to the left each time, or automatically determined or manually adjusted according to a practical application requirement; for example, the user may manually adjust the observation perspective according to an actual situation to obtain a second angle after adjustment. The terminal may re-acquire the plant image and the first point cloud data of the target plant at the second angle, segment the plant image at the second angle, and screen out candidate leaves from the plurality of leaves of the plant image at the second angle.

In this embodiment, when no candidate leaf is screened out from the plurality of leaves of the target plant, the observation perspective corresponding to the target plant is adjusted to obtain a second angle, and a plant image and first point cloud data of the target plant at the second angle are re-acquired, so as to screen out candidate leaves from the plurality of leaves of the plant image at the second angle, which facilitates selection of external front leafs of the target plant from the plant image at the second angle as the target leaf and effectively improves the accuracy of the candidate leaves screened out.

In one embodiment, the step of segmenting the plant image through a leaf segmentation model to obtain a leaf segmentation result includes: generating a leaf segmentation request, the leaf segmentation request carrying the plant image; sending the leaf segmentation request to a server, so that the server, in response to the leaf segmentation request, determines a plant type corresponding to the target plant, calls a pre-trained leaf segmentation model corresponding to the plant type, and inputs the plant image to the leaf segmentation model, to obtain a leaf segmentation result outputted by the leaf segmentation model after segmentation of the plant image; and receiving the leaf segmentation result sent by the server.

After pre-training, the leaf segmentation model can be configured locally in the terminal. In order to save operation resources of the terminal, the leaf segmentation model may also be configured in the server, and the terminal may instruct the server to segment the plant image through the leaf segmentation model, thereby saving the operation resources of the terminal and achieving low coupling characteristics between the server and the terminal.

Specifically, the terminal may communicate with the server based on an established connection. The server may create and provide an IP address (Internet Protocol address) and an API (Application Programming Interface). The terminal, after acquiring the plant image, generates a leaf segmentation request. The generated leaf segmentation request carries the plant image. The leaf segmentation request is configured to indicate segmentation of the plant image. The terminal may send the leaf segmentation request to the server through the IP address and the API provided by the server.

The server may parse the leaf segmentation request in response to the received leaf segmentation request to obtain the plant image carried in the leaf segmentation request. The server may determine a plant type corresponding to the target plant and call a pre-trained leaf segmentation model corresponding to the plant type. Since leaf characteristics of different types of plants are generally different, corresponding leaf segmentation models may be trained for different types of plants. The server may input the plant image into the leaf segmentation model, and segment the plant image through the leaf segmentation model, to obtain a leaf segmentation result outputted by the leaf segmentation model. The leaf segmentation result outputted by the leaf segmentation model may be a binary image. The server may send the leaf segmentation result outputted by the leaf segmentation model to the terminal, and the terminal receives the leaf segmentation result returned by the server.

In this embodiment, the leaf segmentation model is configured in a server, and the terminal generates a leaf segmentation server and sends the leaf segmentation request to the server, so that the server determines a plant type corresponding to the target plant, calls a pre-trained leaf segmentation model corresponding to the plant type, segments the plant image through the leaf segmentation model, and receives a leaf segmentation result sent by the server. The leaf segmentation model is deployed on the server, thereby effectively saving operation resources of the terminal. The server and the terminal have only data coupling therebetween, without other coupling relationships such as external coupling, so as to realize low coupling between the server and the terminal.

In one embodiment, the step of determining a leaf model corresponding to the target leaf according to the first point cloud data and the second point cloud data includes: comparing the first point cloud data with the second point cloud data to obtain difference point cloud data; determining a plant type corresponding to the target plant, and acquiring a standard leaf model corresponding to the plant type; and modifying the standard leaf model according to the difference point cloud data to obtain a target leaf model corresponding to the target leaf.

The first point cloud data is point cloud data corresponding to the target plant prior to shearing of the target leaf, and the second point cloud data is point cloud data corresponding to the target plant after shearing of the target leaf. After acquiring the second point cloud data corresponding to the target plant after shearing, the terminal may compare the first point cloud data with the second point cloud data to obtain difference point cloud data between the first point cloud data and the second point cloud data. For example, the terminal may compare the first point cloud data with the second point cloud data by an octree or a K-D tree to obtain the difference point cloud data. The difference point cloud data corresponds to the sheared target leaf.

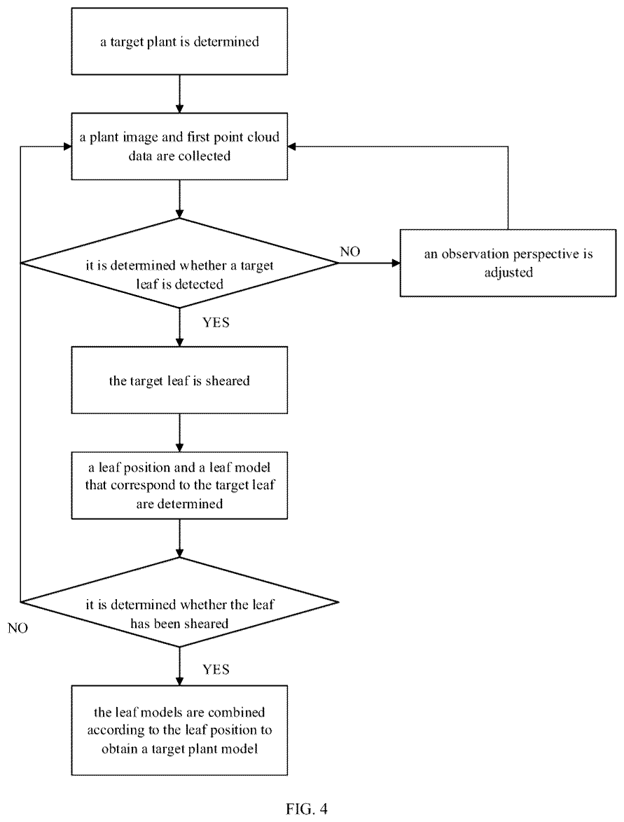

As shown in FIG. 3, FIG. 3(a) is a schematic diagram of first point cloud data according to an embodiment, FIG. 3(b) is a schematic diagram of second point cloud data according to an embodiment; and FIG. 3(c) is a schematic diagram of difference point cloud data according to an embodiment. The part in the square box in FIG. 3(a) and FIG. 3(b) is a region where the sheared target leaf is located. The terminal may acquire the first point cloud data corresponding to the target plant prior to shearing and the second point cloud data corresponding to the target plant after shearing, and may determine difference point cloud data corresponding to the sheared target leaf by comparing the first point cloud data with the second point cloud data, as shown in FIG. 3(c).

The terminal may determine a plant type corresponding to the target plant and acquire a standard leaf model corresponding to the plant type. The standard leaf model corresponds to the plant type. Since leaf characteristics of different types of plants are generally different, different plant types may correspond to different standard leaf models. The standard leaf model may be artificially set based on observation and experience.

The standard leaf model can only represent the leaf characteristic of the corresponding plant type, but different target leaves correspond to different leaf characteristics. Therefore, the terminal can modify the standard leaf model according to the difference point cloud data corresponding to the target leaf to obtain a target leaf model corresponding to the target leaf. For example, the terminal can register the difference point cloud data with the standard leaf model by using an ICP (Iterative Closest Point) algorithm, to obtain the target leaf model corresponding to the target leaf.

In this embodiment, the first point cloud data is compared with the second point cloud data to obtain difference point cloud data, a standard leaf model corresponding to the plant type of the target plant is acquired, and the standard leaf model is modified according to the difference point cloud data to obtain a target leaf model corresponding to the target leaf, which effectively improves the accuracy of the target leaf model, improves the accuracy of the target plant model, and at the same time, compared with the conventional method, does not require the user to manually select a to-be-shared target leaf, thereby effectively improving the efficiency and expansibility of plant model generation.

In one embodiment, after the step of determining a leaf model corresponding to the target leaf according to the first point cloud data and the second point cloud data, the method further includes: determining a leaf position of the target leaf corresponding to the leaf model in the target plant; and repeatedly acquiring the plant image and the first point cloud data that correspond to the target plant after shearing until leaf models corresponding to a plurality of leaves of the target plant respectively are determined; and the step of generating a target plant model corresponding to the target plant according to the leaf model includes: combining the leaf models corresponding to the plurality of leaves respectively according to the leaf position to obtain the target plant model.

Since the target plant generally corresponds to more leaves, the terminal may repeatedly determine a to-be-sheared target leaf corresponding to the target plant, and determine a leaf model corresponding to the target leaf after shearing of the target leaf, so as to generate a target plant model corresponding to the target plant according to leaf models corresponding to a plurality of leaves respectively, thereby improving accuracy and completeness of generation of the target plant model.

After determining the leaf model corresponding to the target leaf according to the first point cloud data and the second point cloud data, the terminal may determine a leaf position of the target leaf corresponding to the leaf model in the target plant. Specifically, the terminal may compare the first point cloud data with the second point cloud data to obtain difference point cloud data between the first point cloud data and the second point cloud data. The difference point cloud data corresponds to the target leaf. The difference point cloud data includes coordinates corresponding to the target leaf. The terminal may determine the leaf position corresponding to the target leaf according to the difference point cloud data.

The terminal may repeatedly acquire the plant image and the first point cloud data that correspond to the target plant after shearing, determine next to-be-sheared target leaf according to the plant image corresponding to the target plant after shearing, and determine a leaf position and a leaf model that correspond to the next to-be-sheared target leaf until leaf positions and leaf models corresponding to the plurality of leaves of the target plant are determined. In one embodiment, the terminal may repeatedly determine the to-be-sheared target leaf and shear the target leaf to determine leaf positions and leaf models corresponding to leaves of the target plant respectively. The terminal may combine the leaf models corresponding to a plurality of leaves respectively according to the leaf positions corresponding to the leaves respectively to obtain the target plant model corresponding to the target plant.

As shown in FIG. 4, FIG. 4 is a schematic flowchart of plant model generation according to an embodiment. After a target plant is determined, a plant image and first point cloud data that correspond to a target plant may be collected through a data collection device, and it is determined whether a target leaf is detected through the plant image. If no, an observation perspective corresponding to the target plant is adjusted and the plant image and the first point cloud data are re-acquired. If yes, the target leaf is sheared, second point cloud data corresponding to the target plant after shearing is acquired, and a leaf position and a leaf model that correspond to the target leaf are determined according to the first point cloud data and the second point cloud data. It is determined whether the leaf of the target plant has been sheared, and if no, a plant image and first point cloud data that correspond to the target plant after shearing are repeatedly acquired. If yes, the leaf models corresponding to a plurality of leaves respectively are combined according to the leaf position to obtain a target plant model corresponding to the target plant.

In this embodiment, a leaf position of the target leaf in the target plant is determined, a plant image and first point cloud data that correspond to the target plant after shearing are repeatedly acquired until leaf models corresponding to a plurality of leaves of the target plant respectively are determined, and the leaf models corresponding to the plurality of leaves respectively are combined according to the leaf position to obtain the target plant model. Leaf models and leaf positions corresponding to the plurality of leaves are repeatedly determined, which effectively improves accuracy and completeness of the target plant model obtained by combining the leaf positions and the leaf models.

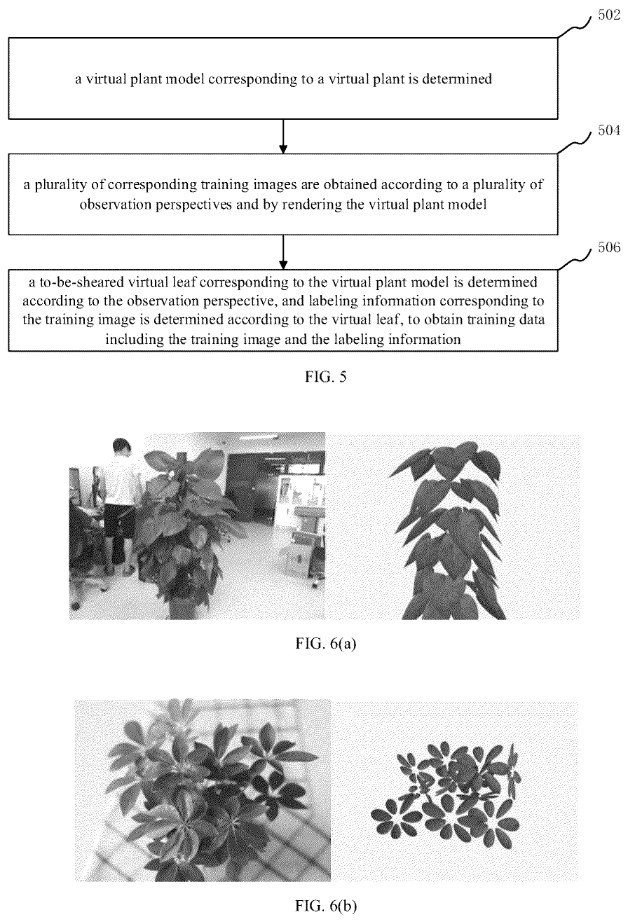

In one embodiment, as shown in FIG. 5, the leaf segmentation model is obtained by pre-training according to training data, and a step of generating the training data includes the following steps.

In step 502, a virtual plant model corresponding to a virtual plant is determined.

The leaf segmentation model is obtained by pre-training an instance segmentation network according to the training data. A large amount of training data is generally needed to obtain the leaf segmentation model by training the instance segmentation network. In the conventional method, training images are generally collected manually and labeled manually, which requires a lot of time and energy, and the generation efficiency of training data is low. In this embodiment, the terminal may render a virtual plant model to obtain training data for model training, thereby effectively improving the generation efficiency of the training data.

Specifically, the terminal may determine a virtual plant type corresponding to a virtual plant. The plant type corresponding to the virtual plant may correspond to the plant type corresponding to the target plant. The virtual plant model may be artificially set by the user according to a practical application requirement. For example, to enable the virtual plant to be as close as possible to a real plant, leaf similarity and leaf distribution similarity of the virtual plant model are required to be taken into account. For a virtual leaf model corresponding to the virtual plant model, a parameterized leaf model defined by a Bezier curve may be adopted. The leaf model is similar to a real leaf by adjusting parameters of the parameterized leaf model. In one embodiment, the parameters may also be perturbed randomly within a preset range, so as to obtain leaf models belonging to a same plant type but not exactly the same in shape. The parameterized leaf model is combined according to leaf distribution of the real plant, so as to obtain the virtual plant model corresponding to the virtual plant.

In step 504, a plurality of corresponding training images are obtained according to a plurality of observation perspectives and by rendering the virtual plant model.

The terminal may render the virtual plant model according to a plurality of observation perspectives to obtain a plurality of training images corresponding to the virtual plant model at the plurality of observation perspectives. A same observation perspective may also correspond to one, two or more training images. The training image may specifically be an RGB image. In one embodiment, the training image may include a plant training image or include a plant training image and a background image.

In step 506, a to-be-sheared virtual leaf corresponding to the virtual plant model is determined according to the observation perspective, and labeling information corresponding to the training image is determined according to the virtual leaf, to obtain training data including the training image and the labeling information.

The terminal may determine the labeling information corresponding to the corresponding training image according to the observation perspective and the virtual plant model, so as to obtain the training data including the training image and the labeling information. Specifically, the terminal may determine the to-be-sheared virtual leaf corresponding to the virtual plant model according to the observation perspective. The to-be-sheared virtual leaf is a virtual external leaf of the virtual plant that is not occluded and faces as far as possible towards an observation point.

The terminal may select, from a plurality of virtual leaves according to a leaf orientation and an observation perspective of the virtual plant model, the virtual leaf facing the observation point. Specifically, the terminal may calculate angles between directions corresponding to leaf orientations and observation perspectives of the virtual leaves, and select, according to the angles, the virtual leaf facing the observation point. The leaf orientation may be determined according to normal vectors of a plurality of vertices. The leaf orientation of the virtual leaf may be specifically expressed as:

$$\vec{{t}_{L}} = \frac{1}{n} {\sum }_{v ∈ L} {w}_{v} * \vec{{n}_{v}}$$

where L denotes the virtual leaf model, and \vec{t_{L}} denotes the leaf orientation. v denotes a vertex corresponding to the virtual leaf, \vec{nᵥ} denotes a normal vector corresponding to the vertex, and wᵥ denotes a weight corresponding to the vertex.

The terminal may determine an angle between a leaf orientation and an observation direction, and when the angle between the leaf orientation and the observation direction is less than a preset threshold, determine that the virtual leaf faces the observation point. The terminal may determine an occlusion relationship between the virtual leaves according to depth cache information corresponding to the virtual plant model, and select the to-be-sheared virtual leaf according to the angles between the leaf orientations and the observation perspectives. The terminal may determine, according to a projection principle, a pixel position of the to-be-sheared leaf in a training image obtained by rendering, so as to determine standard information corresponding to the training image and obtain training data including the training image and the labeling information.

In this embodiment, a virtual plant model corresponding to the virtual plant is determined, a plurality of corresponding training images are obtained according to a plurality of observation perspectives and by rendering the virtual plant model, a to-be-sheared virtual leaf corresponding to the virtual plant model is determined according to the observation perspective, and labeling information corresponding to the training image is determined according to the virtual leaf, to obtain training data including the training image and the labeling information, which, compared with the conventional manual collection and labeling method, reduces the time spent on the collection and labeling of the training data and effectively improves the generation efficiency of the training data.

In one embodiment, in order to verify the accuracy of the plant model generation method according to the present disclosure and save verification costs generated by a real plant, a virtual plant can be used for simulation, and a plant models corresponding to the virtual plant can be generated for verification. Specifically, after the plant image is segmented, in order to improve the efficiency of determining the to-be-sheared virtual leaf, leaf indexes corresponding to virtual leaves of the virtual plant can be established. For example, the leaf indexes may specifically be an array. The terminal may linearly map the leaf indexes into an RGB space and generate leaf index images of different virtual leaves represented in different colors, so as to determine the segmentation result more intuitively and clearly.

The linear mapping of the leaf indexes into the RGB space may be specifically expressed as:

$${C}_{i} = \{ \begin{matrix}255 , & idx > N * i \\ ( idx mod N ) * G , & others\end{matrix}$$

where C denotes an RGB color, and i denotes a corresponding color channel. idx denotes a leaf index corresponding to a virtual leaf, and N denotes a number of leaves that can be represented by each color channel. G denotes a color interval value between leaf indexes.

The terminal, after segmenting the plant image through the leaf segmentation model, determines a pixel position corresponding to the to-be-sheared virtual leaf according to a leaf segmentation result, and a leaf index can be quickly determined according to a color of a corresponding pixel position in a leaf index image, so as to obtain the to-be-sheared virtual leaf, which effectively improves the efficiency and visibility of determining the to-be-sheared virtual leaf.

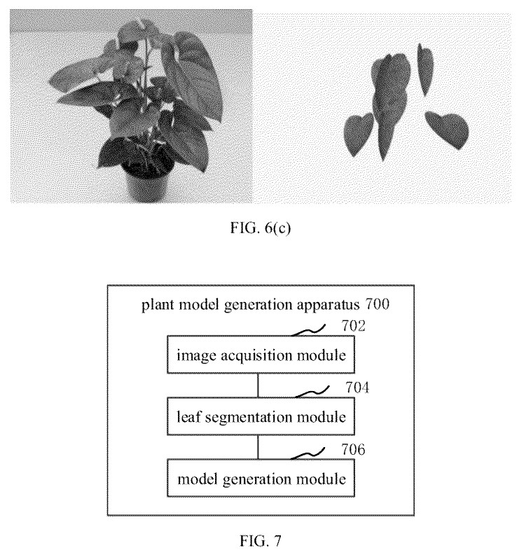

In this embodiment, three types of plants, Scindapsus aureus, Schefflera octophylla and Anthurium andraeanum, are simulated and detected respectively in the manner in the above method embodiment. As shown in FIG. 6, FIG. 6(a) is a schematic diagram of simulation corresponding to Scindapsus aureus according to an embodiment, FIG. 6(b) is a schematic diagram of simulation corresponding to Schefflera octophylla according to an embodiment, and FIG. 6(c) is a schematic diagram of simulation of Anthurium andraeanum according to an embodiment. The terminal may model a simulated virtual plant and generate a plant model corresponding to the virtual plant, so as to detect the accuracy of the above plant model generation method. Assessment results of the virtual plant model are specifically shown in a table below:

| Plant type | S | n | PL | MP | ML |
|---|---|---|---|---|---|
| Virtual Scindapsus aureus | 33 | 33 | 100.0% | 99.4% | 98.3% |
| Virtual Schefflera octophylla | 62 | 48 | 77.4% | 81.6% | 76.5% |
| Virtual Anthurium andraeanum | 10 | 10 | 100.0% | 96.8% | 95.7% |

where S denotes a total number of leaves corresponding to a virtual plant, and n denotes a number of leaves with better results. M_{P} denotes a coincidence degree of the whole plant, M_{L} denotes an average leaf coincidence degree, and P_{L} denotes a ratio of the number of the leaves with better results to the total number of leaves. It can be seen from the assessment results that the manner in the above method embodiment can accurately and completely generate the target plant model corresponding to the target plant.

It should be understood that although the steps in the flowcharts of FIG. 2 and FIG. 5 are displayed in sequence as indicated by the arrows, the steps are not necessarily performed in the order indicated by the arrows. Unless otherwise clearly specified herein, the steps are performed without any strict sequence limitation, and may be performed in other orders. In addition, at least some steps in FIG. 2 and FIG. 5 may include a plurality of sub-steps or a plurality of stages, and these sub-steps or stages are not necessarily performed at a same moment, and may be performed at different moments. The sub-steps or stages are not necessarily performed in sequence, and the sub-steps or stages and at least some of other steps or sub-steps or stages of other steps may be performed in turn or alternately.

In one embodiment, as shown in FIG. 7, a plant model generation apparatus 700 is provided, including: an image acquisition module 702, a leaf segmentation module 704 and a model generation module 706.

The image acquisition module 702 is configured to acquire a plant image and first point cloud data that correspond to a target plant.

The leaf segmentation module 704 is configured to segment the plant image through a leaf segmentation model to obtain a leaf segmentation result, and determine a to-be-sheared target leaf according to the leaf segmentation result; and shear the target leaf of the target plant to acquire second point cloud data corresponding to the target plant after shearing.

The model generation module 706 is configured to determine a leaf model corresponding to the target leaf according to the first point cloud data and the second point cloud data, and generate a target plant model corresponding to the target plant according to the leaf model.

In one embodiment, the leaf segmentation module 704 is further configured to determine confidence degrees corresponding to a plurality of leaves of the target plant respectively according to the leaf segmentation result; screen out candidate leaves from the plurality of leaves of the target plant according to the confidence degrees; and select, from the candidate leaves, the candidate leave satisfying a selection condition as the target leaf, wherein the selection condition includes the confidence degree being greater than a confidence degree threshold or the confidence degree being sorted prior to at least one of those pre-sorted.

In one embodiment, the plant image and the first point cloud data are acquired with a first angle as an observation perspective, and the leaf segmentation module 704 is further configured to adjust the observation perspective corresponding to the target plant to obtain a second angle when no candidate leaf is screened out from the plurality of leaves of the target plant; and re-acquire the plant image and the first point cloud data of the target plant at the second angle.

In one embodiment, the leaf segmentation module 704 is further configured to generate a leaf segmentation request, the leaf segmentation request carrying the plant image; send the leaf segmentation request to a server, so that the server, in response to the leaf segmentation request, determines a plant type corresponding to the target plant, calls a pre-trained leaf segmentation model corresponding to the plant type, and inputs the plant image to the leaf segmentation model, to obtain a leaf segmentation result outputted by the leaf segmentation model after segmentation of the plant image; and receive the leaf segmentation result sent by the server.

In this embodiment, the model generation module 706 is further configured to determine a leaf position of the target leaf corresponding to the leaf model in the target plant; repeatedly acquire the plant image and the first point cloud data that correspond to the target plant after shearing until leaf models corresponding to a plurality of leaves of the target plant respectively are determined; and combine the leaf models corresponding to the plurality of leaves respectively according to the leaf position to obtain the target plant model.

In one embodiment, the model generation module 706 is further configured to compare the first point cloud data with the second point cloud data to obtain difference point cloud data; determine a plant type corresponding to the target plant, and acquiring a standard leaf model corresponding to the plant type; and modify the standard leaf model according to the difference point cloud data to obtain a target leaf model corresponding to the target leaf.

In this embodiment, the leaf segmentation model is obtained by pre-training according to training data, and the plant model generation apparatus 700 further includes a training data generation module configured to determine a virtual plant model corresponding to a virtual plant; obtain a plurality of corresponding training images by rendering according to a plurality of observation perspectives and the virtual plant model; and determine a to-be-sheared virtual leaf corresponding to the virtual plant model according to the observation perspective, and determine labeling information corresponding to the training image according to the virtual leaf, to obtain training data including the training image and the labeling information.

Specific limitations on the plant model generation apparatus can be obtained with reference to the limitations on the plant model generation method hereinabove, and are not described in detail herein. Each module in the plant model generation apparatus may be entirely or partially implemented by using software, hardware, or a combination thereof. The above modules may be built in or independent of a processor of a computer device in a hardware form, or may be stored in a memory of the computer device in a software form, so that the processor calls and performs an operation corresponding to each of the above modules.

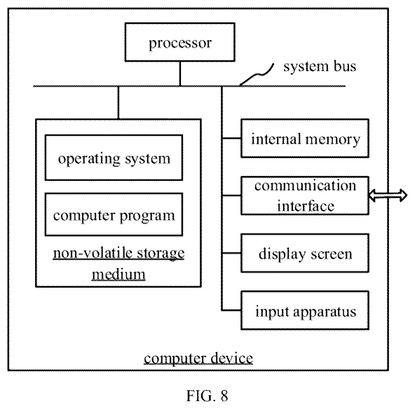

In one embodiment, a computer device is provided. The computer device may be a terminal, and its internal structure may be shown in FIG. 8. The computer device includes a processor, a memory, a communication interface, a display screen and an input apparatus that are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for running of the operating system and the computer program in the non-volatile storage medium. The communication interface of the computer device is configured to communicate with an external terminal in a wired or wireless manner. The wireless manner may be implemented through WIFI, a carrier network, NFC (near field communication), or other technologies. The computer program implements a plant model generation method when executed by the processor. The display screen of the computer device may a liquid crystal display screen or an electronic ink display screen. The input apparatus of the computer device may be a touch layer covering the display screen, or may be a key, a trackball, or a touchpad disposed on a housing of the computer device, or may be an external keyboard, a touchpad, a mouse, or the like.

Those skilled in the art may understand that a structure shown in FIG. 8 is only a block diagram of some structures related to the solution of the present disclosure and constitutes no limitation on the computer device to which the solution of the present disclosure is applied. Specifically, the computer device may include more or fewer components than those shown in the drawings, or some components may be combined, or a different component deployment may be used.

In one embodiment, a computer device is provided, including a memory and a processor. The memory stores a computer program, and the computer program, when executed by the processor, implements steps in the embodiment of the plant model generation method.

In one embodiment, a computer-readable storage medium is provided, having a computer program stored thereon. The computer program, when executed by a processor, implements steps in the embodiment of the plant model generation method.

Those of ordinary skill in the art may understand that all or some procedures in the methods in the foregoing embodiments may be implemented by a computer-readable instruction instructing related hardware, the computer program may be stored in a non-volatile computer-readable storage medium, and when the computer program is executed, the procedures in the foregoing method embodiments may be implemented. Any reference to a memory, a storage, a database, or other media used in the embodiments according to the present disclosure may include a non-volatile and/or volatile memory. The non-volatile memory may include a read-only memory (ROM), a magnetic tape, a floppy disk, a flash memory, an optical memory and the like. The volatile memory may include a random access memory (RAM) or an external high-speed cache memory. By way of illustration instead of limitation, the RAM is available in a variety of forms, such as a static RAM (SRAM), a dynamic RAM (DRAM) and the like.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several implementations of the present disclosure, which are described specifically and in detail, and therefore cannot be construed as a limitation on the invention patent scope. It should be pointed out that those of ordinary skill in the art may also make several changes and improvements without departing from the ideas of the present disclosure, all of which fall within the protection scope of the present disclosure. Therefore, the patent protection scope of the present disclosure shall be subject to the appended claims.

What is claimed is:

1. A plant model generation method, comprising:
acquiring a plant image and first point cloud data that correspond to a target plant;
segmenting the plant image through a leaf segmentation model to obtain a leaf segmentation result, and determining a to-be-sheared target leaf according to the leaf segmentation result;
shearing the target leaf of the target plant to acquire second point cloud data corresponding to the target plant after shearing; and
determining a leaf model corresponding to the target leaf according to the first point cloud data and the second point cloud data, and generating a target plant model corresponding to the target plant according to the leaf model.

2. The method according to claim 1, wherein the step of determining a to-be-sheared target leaf according to the leaf segmentation result comprises:
determining confidence degrees corresponding to a plurality of leaves of the target plant respectively according to the leaf segmentation result;
screening out candidate leaves from the plurality of leaves of the target plant according to the confidence degrees; and
selecting, from the candidate leaves, the candidate leave satisfying a selection condition as the target leaf, wherein the selection condition comprises the confidence degree being greater than a confidence degree threshold or the confidence degree being sorted prior to at least one of those pre-sorted.

3. The method according to claim 2, wherein the plant image and the first point cloud data are acquired with a first angle as an observation perspective, and the method further comprises:
adjusting the observation perspective corresponding to the target plant to obtain a second angle when no candidate leaf is screened out from the plurality of leaves of the target plant; and
re-acquiring the plant image and the first point cloud data of the target plant at the second angle.

4. The method according to claim 1, wherein the step of segmenting the plant image through a leaf segmentation model to obtain a leaf segmentation result comprises:
generating a leaf segmentation request, the leaf segmentation request carrying the plant image; and
sending the leaf segmentation request to a server, so that the server, in response to the leaf segmentation request, determines a plant type corresponding to the target plant, calls a pre-trained leaf segmentation model corresponding to the plant type, and inputs the plant image to the leaf segmentation model, to obtain a leaf segmentation result outputted by the leaf segmentation model after segmentation of the plant image; and
receiving the leaf segmentation result sent by the server.

5. The method according to claim 1, further comprising: after the step of determining a leaf model corresponding to the target leaf according to the first point cloud data and the second point cloud data,
determining a leaf position of the target leaf corresponding to the leaf model in the target plant; and
repeatedly acquiring the plant image and the first point cloud data that correspond to the target plant after shearing until leaf models corresponding to a plurality of leaves of the target plant respectively are determined; and
the step of generating a target plant model corresponding to the target plant according to the leaf model comprises: combining the leaf models corresponding to the plurality of leaves respectively according to the leaf position to obtain the target plant model.

6. The method according to claim 1, further comprising: after the step of determining a leaf model corresponding to the target leaf according to the first point cloud data and the second point cloud data,
repeatedly determining the to-be-sheared target leaf and shearing the target leaf to determine leaf positions and leaf models corresponding to leaves of the target plant respectively; and
combining the leaf models corresponding to a plurality of leaves respectively according to the leaf positions corresponding to the leaves respectively to obtain the target plant model corresponding to the target plant.

7. The method according to claim 1, wherein the step of determining a leaf model corresponding to the target leaf according to the first point cloud data and the second point cloud data comprises:
comparing the first point cloud data with the second point cloud data to obtain difference point cloud data;
determining a plant type corresponding to the target plant, and acquiring a standard leaf model corresponding to the plant type; and
modifying the standard leaf model according to the difference point cloud data to obtain a target leaf model corresponding to the target leaf.

8. The method according to claim 1, wherein the leaf segmentation model is obtained by pre-training according to training data, and a step of generating the training data comprises:
determining a virtual plant model corresponding to a virtual plant;
obtaining a plurality of corresponding training images by rendering according to a plurality of observation perspectives and the virtual plant model; and
determining a to-be-sheared virtual leaf corresponding to the virtual plant model according to the observation perspective, and determining labeling information corresponding to the training image according to the virtual leaf, to obtain training data comprising the training image and the labeling information.

9. A plant model generation method, comprising:
collecting a plant image and first point cloud data that correspond to a target plant, and determining whether a target leaf is detected through the plant image;
adjusting an observation perspective corresponding to the target plant and re-acquiring the plant image and the first point cloud data if no;
shearing the target leaf to acquire second point cloud data corresponding to the target plant after shearing if yes;
determining a leaf position and a leaf model that correspond to the target leaf according to the first point cloud data and the second point cloud data; and
determining whether the leaf of the target plant has been sheared;
re-acquiring the plant image and the first point cloud data that corresponding to the target plant after shearing if no; and
combining the leaf models corresponding to a plurality of leaves respectively according to the leaf position to obtain a target plant model corresponding to the target plant.

10. A plant model generation apparatus, comprising:
an image acquisition module configured to acquire a plant image and first point cloud data that correspond to a target plant;
a leaf segmentation module configured to segment the plant image through a leaf segmentation model to obtain a leaf segmentation result, and determine a to-be-sheared target leaf according to the leaf segmentation result; and shear the target leaf of the target plant to acquire second point cloud data corresponding to the target plant after shearing; and
a model generation module configured to determine a leaf model corresponding to the target leaf according to the first point cloud data and the second point cloud data, and generate a target plant model corresponding to the target plant according to the leaf model.

11. The apparatus according to claim 10, wherein the leaf segmentation module is further configured to:
determine confidence degrees corresponding to a plurality of leaves of the target plant respectively according to the leaf segmentation result;
screen out candidate leaves from the plurality of leaves of the target plant according to the confidence degrees; and
select, from the candidate leaves, the candidate leave satisfying a selection condition as the target leaf, wherein the selection condition comprises the confidence degree being greater than a confidence degree threshold or the confidence degree being sorted prior to at least one of those pre-sorted.

12. The apparatus according to claim 11, wherein the plant image and the first point cloud data are acquired with a first angle as an observation perspective, and the leaf segmentation module is further configured to:
adjust the observation perspective corresponding to the target plant to obtain a second angle when no candidate leaf is screened out from the plurality of leaves of the target plant; and
re-acquire the plant image and the first point cloud data of the target plant at the second angle.

13. The apparatus according to claim 10, wherein the leaf segmentation module is further configured to:
generate a leaf segmentation request, the leaf segmentation request carrying the plant image;
send the leaf segmentation request to a server, so that the server, in response to the leaf segmentation request, determines a plant type corresponding to the target plant, calls a pre-trained leaf segmentation model corresponding to the plant type, and inputs the plant image to the leaf segmentation model, to obtain a leaf segmentation result outputted by the leaf segmentation model after segmentation of the plant image; and
receive the leaf segmentation result sent by the server.

14. The apparatus according to claim 10, wherein the model generation module is further configured to:
determine a leaf position of the target leaf corresponding to the leaf model in the target plant; and
repeatedly acquire the plant image and the first point cloud data that correspond to the target plant after shearing until leaf models corresponding to a plurality of leaves of the target plant respectively are determined; and
combine the leaf models corresponding to a plurality of leaves respectively according to the leaf position to obtain a target plant model.

15. The apparatus according to claim 10, wherein the model generation module is further configured to:
repeatedly determine the to-be-sheared target leaf and shear the target leaf to determine leaf positions and leaf models corresponding to leaves of the target plant respectively; and
combine the leaf models corresponding to a plurality of leaves respectively according to the leaf positions corresponding to the leaves respectively to obtain the target plant model corresponding to the target plant.

16. The apparatus according to claim 10, wherein the model generation module is further configured to:
compare the first point cloud data with the second point cloud data to obtain difference point cloud data;
determine a plant type corresponding to the target plant, and acquire a standard leaf model corresponding to the plant type; and
modify the standard leaf model according to the difference point cloud data to obtain a target leaf model corresponding to the target leaf.

17. The apparatus according to claim 10, wherein the leaf segmentation model is obtained by pre-training according to training data, and the plant model generation apparatus further comprises a training data generation module configured to:
determine a virtual plant model corresponding to a virtual plant;
obtain a plurality of corresponding training images by rendering according to a plurality of observation perspectives and the virtual plant model; and
determine a to-be-sheared virtual leaf corresponding to the virtual plant model according to the observation perspective, and determine labeling information corresponding to the training image according to the virtual leaf, to obtain training data comprising the training image and the labeling information.

18. (canceled)

19. A computer-readable storage medium, having a computer program stored thereon, the computer program, when executed by a processor, implementing steps of the method according to claim 1.
